(19) United States
(12) Patent Application Publication
(10) Pub. No.: US 2023/0062208 A1
(43) Pub. Date: Mar. 2, 2023

(54) SYSTEMS AND METHODS PROVIDING A USER INTERFACE (UI) BETWEEN AN AIR TRAFFIC CONTROL-PILOT CONVERSATION AND A DESTINATION AVIONICS SYSTEM

(71) Applicant: HONEYWELL INTERNATIONAL INC., Charlotte, NC (US)

(72) Inventors: Hariharan Saptharishi, Madurai (IN); Gobinathan Baladhandapani, Madurai (IN); Pavan Gupta, Bangalore (IN); Reena Natarajan, Bangalore (IN)

(73) Assignee: HONEYWELL INTERNATIONAL INC., Charlotte, NC (US)

(21) Appl. No.: 17/449,839

(22) Filed: Oct. 4, 2021

(30) Foreign Application Priority Data
Aug. 20, 2021 (IN) 202111037793

(51) Int. Cl. G08G 5/00; G10L 15/26; G06F 3/0483

(52) U.S. Cl. CPC G08G 5/0013; G08G 5/0021; G08G 5/003; G10L 15/26; G06F 3/0483

(57) ABSTRACT

Systems and methods for providing a user interface (UI) between an air traffic control transcription (ATCT) page on a portable device and a destination avionics system. The method includes parsing ATC messages into a target avionic system and respective avionic data, mapping the target avionic system to a destination avionic system, and rendering a target UI button on the ATCT page. The method displays a data preview window with the respective avionic data and a GUI object representing each of one or more destination avionic systems, which, when selected, causes the avionic data to be sent to the selected destination avionic system. The method also enables user activity on a cockpit display page to update the ATCT page with relevant updates.

### CROSS REFERENCE TO RELATED APPLICATION

The present application claims benefit of prior filed India Provisional Patent Application No. 202111037793, filed Aug. 20, 2021, which is hereby incorporated by reference herein in its entirety.

### TECHNICAL FIELD

The following disclosure generally relates to flight display systems. More particularly, the following disclosure relates to systems and methods providing a user interface (UI) between an air traffic control-pilot conversation and a destination avionics system.

### BACKGROUND

A technical problem is presented in aviation environments when equipment settings are incorrect before or during a flight. A solution is to have the pilot perform many cross-checking operations. The cross-checking process is intended to reduce the likelihood of errors. The cross-checking process conventionally involves verbal and visual verification of an intended action in the cockpit prior to its execution. The visual verification generally involves checking equipment settings, altimeter pressure settings, a cleared altitude, a frequency change requirement, and navigation routings. When there is more than one pilot, cross-checking may be enhanced by having one pilot set the equipment settings and a second pilot cross-check them. Often, the cross validation is either done through keypad entry noted while receiving an ATC clearance or playback in an audio panel.

However, a technical problem continues to exist because both approaches increase crew workload. Playback audio often can store only few clearances, and Human error is possible in keypad entry. The cross-checking process may fail because of a misheard message, fatigue, a memory lapse, an incorrect or incomplete appreciation of the situation, an insufficient crosscheck, language barriers, distraction, communication problems, ineffective monitoring, a data use error, a non-compliance with Standard Operating Procedures (SOP), and the like. These errors can occur irrespective of pilot experience, aircraft type, or location. Additionally, in Single Pilot Operations (SPO), there is no second pilot to perform cross-checking.

Accordingly, improved flight display systems and methods that close the loop on the potential for cross-checking errors are desirable. The desirable flight display system will provide a user interface (UI) between an air traffic control (ATC)-pilot conversation on a portable device and a destination avionics system. Furthermore, other desirable features and characteristics of the disclosure will become apparent from the subsequent detailed description and the appended claims, taken in conjunction with the accompanying drawings, brief summary, technical field, and this background of the disclosure.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

Provided is a system providing a user interface (UI) between an air traffic control transcription (ATCT) page on a portable device and a destination avionics system, the system comprising: a parser module configured to: receive an air traffic control (ATC) message; parse the ATC message into a target avionic system and a respective avionic data; map the target avionic system to a destination avionic system; and store in a clearance database, execution data comprising the ATC message, the target avionic system, the destination avionic system, and the respective avionic data; a user interface (UI) generator module configured to: render, on the ATCT page, a target UI button to indicate the target avionic system in the ATC message; display, responsive to a user selection of the target UI button, a data preview window comprising the respective avionic data and a GUI object representing the destination avionic system; and a coordinator module configured to send the avionic data to the destination avionic system, responsive to a user selection of the GUI object representing the destination avionic system.

Also provided is a method providing a user interface (UI) between an air traffic control transcription (ATCT) page on a portable device and a destination avionics system, the method comprising: at a controller circuit, receiving an air traffic control (ATC) message; parsing the ATC message into a target avionic system and a respective avionic data; mapping the target avionic system to a destination avionic system; and rendering, on the ATCT page, a target UI button to indicate the target avionic system in the ATC message; displaying, responsive to a user selection of the target UI button, a data preview window comprising the respective avionic data and a GUI object representing the destination avionic system; and sending the avionic data to the destination avionic system, responsive to a user selection of the GUI object representing the destination avionic system.

Provided is another system providing a user interface (UI) between an air traffic control transcription (ATCT) page on a portable device and multiple destination avionic systems onboard an aircraft, the system comprising: a processor operationally coupled to the portable device and the multiple destination avionic systems, and configured to: receive an air traffic control (ATC) message; parse the ATC message into a target avionic system and a respective avionic data; map the target avionic system to a destination avionic system of the multiple destination avionic systems on the aircraft; and render, on the ATCT page, a target UI button to indicate the target avionic system in the ATC message; display, responsive to a user selection of the target UI button, a data preview window comprising the respective avionic data and a GUI object representing the destination avionic system; and sending the avionic data to the destination avionic system, responsive to a user selection of the GUI object representing the destination avionic system.

Furthermore, other desirable features and characteristics of the system and method will become apparent from the subsequent detailed description and the appended claims, taken in conjunction with the accompanying drawings and the preceding background.

### BRIEF DESCRIPTION OF THE DRAWING FIGURES

At least one example of the present invention will hereinafter be described in conjunction with the following figures, wherein like numerals denote like elements, and:

FIG. 1 shows a functional block diagram of an aircraft including various systems, including a system for providing a user interface (UI) between an ATC-pilot conversation window on a portable device and a destination avionics system, in accordance with exemplary embodiments of the present disclosure;

FIG. 2 is an architectural block diagram of one or more application modules that may be operating in the system for providing a user interface (UI) between an air traffic control ATC-Pilot conversation window on a portable device and a destination avionics system, in accordance with exemplary embodiments of the present disclosure;

FIG. 3 is a flowchart illustrating a method for providing a user interface (UI) between an air traffic control ATC-Pilot conversation window on a portable device and a destination avionics system, in accordance with exemplary embodiments of the present disclosure; and

FIGS. 4-5 provide example use cases for exemplary embodiments of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any weather or flight display system or method embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, programmable logic arrays, application specific integrated circuits, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

As mentioned, a technical problem continues to exist in confirming equipment settings during flight operations because conventional solutions rely on cross-checking procedures. As described above, the cross-checking process may fail for a variety of reasons.

Accordingly, improved flight display systems and methods that close the loop on the potential for cross-checking errors are desirable. Generally disclosed herein are systems and methods for providing a user interface (UI) between an air traffic control ATC-Pilot conversation window on a portable device and a destination avionics system. This applies in a context in which an air traffic control transcription (ATCT) window may be displayed on a display device within a portable electronic device, and an avionics systems control page or cockpit display page, such as an FMS page, may be displayed on a display device in a cockpit of the aircraft. Provided embodiments determine context and identify target avionics for each ATC clearance message.

As will be described with more context below, the following examples of terms are provided: In various embodiments, “target avionic system” is a general category, such as a radio, and a “destination avionic system” is a specific avionic system, for example, with respect to “radio,” the destination avionic system could be Communication 1 active, Communication 1 standby, Navigation radio 1 or Navigation radio 2. In other embodiments, the “target avionic system” can be a page where the pilot entry will be made or the system where the data will be disabled such as Radio tuning, Flight controls etc.

While the following exemplary embodiments are discussed in terms of an aircraft in flight, it should be appreciated that other embodiments may be employed in other contexts, such as ocean-faring vessels, rail-travelling locomotives, automobiles, and the like. Embodiments of the disclosure may be implemented wherever a user may be dividing operating attention between a display on a portable electronic device and display mounted with a vehicle.

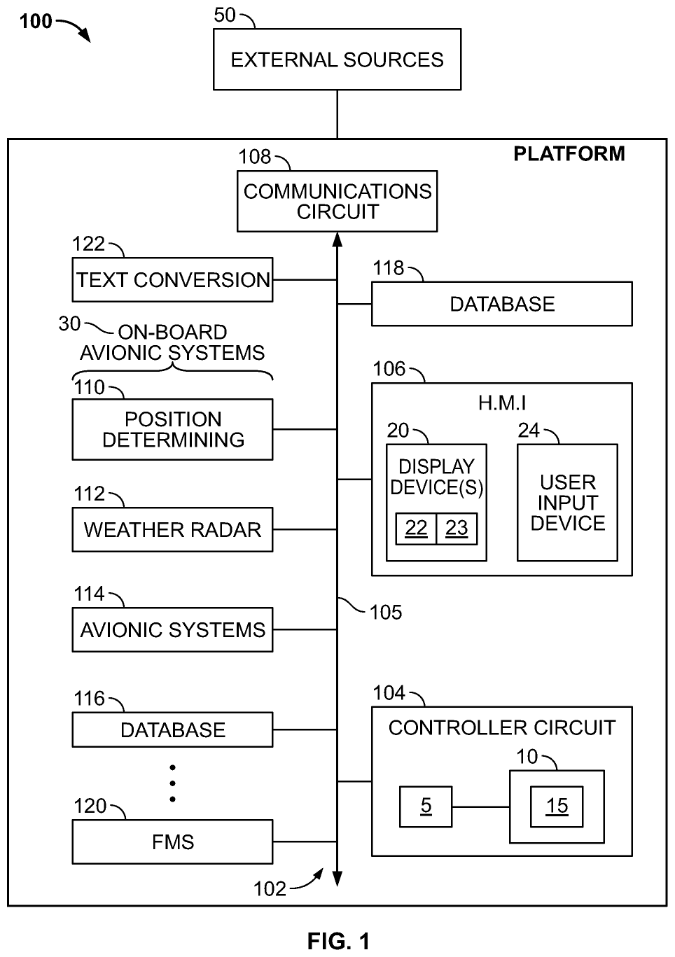

FIG. 1 is a block diagram of a system for providing a user interface (UI) between an air traffic control ATC-Pilot conversation window on a portable device and a destination avionics system (shortened herein to “system” 102), in accordance with an exemplary and non-limiting embodiment of the present disclosure. The system 102 may be utilized onboard a mobile platform as described herein. In various embodiments, the mobile platform is an aircraft 100, which carries or is equipped with the system 102. Aircraft 100 may be any type of vehicle that can travel through the air (i.e., without physical contact with terrain or water). As such, aircraft 100 may be any type of airplane (regardless of size or propulsion means, ranging from large, turbine-powered commercial airplanes to small, electrically-powered aircraft), rotorcraft (helicopter, gyrocopter), lighter-than-air vessel (hot-air balloon, blimp), or glider, for example.

As schematically depicted in FIG. 1, system 102 includes the following components or subsystems, each of which may assume the form of a single device or multiple interconnected devices: a controller circuit 104 operationally coupled to: an HMI 106 (human-machine interface); a communications circuit 108; one or more on-board systems 30, including an FMS 120, and a clearance database 118. In various embodiments, the controller circuit 104 communicates with the components of the system 102 via a communication bus 105.

An ATC clearance message, shortened herein to ATC message, is referred to herein. The ATC message represents an originally received ATC message that has further been converted from speech to text if it was not originally received as text. The speech to text conversion and sorting of text into ATC messages is understood to be performed by existing components, as known in the industry. A source 122 is shown as a source of the text-formatted ATC message and indicates a consolidation of these existing components. Some non-limiting examples of sources of the original ATC message include a communication radio (COM), pilot audio from within the cockpit, Datalink, and aircraft communication addressing and reporting system (ACARS).

The human-machine interface, HMI 106, may include one or more display device(s) 20 and a user input device 24. The user input device 24 may include any combination of a keyboard, cursor control device, voice input device, gesture input apparatus, or the like. In various embodiments, the HMI 106 is an integration of a user interface 18 and a display device 20.

The display device(s) 20 can include any number and type of fixed, onboard, image generating devices on which one or more flight management system (FMS) pages 23 may be produced/displayed for controlling avionic systems 30 (accordingly, FMS pages 23 may also be referred to as avionic pages). The display device(s) 20 can include any number and type of image generating devices located on a portable electronic device, providing one or more pilot-ATCT pages 22 for the pilot to review and respond to Air Traffic Communication Transcription (ATCT). The display device(s) 20 may be embodied as a touch screen display. When the system 102 is utilized for a manned aircraft, display device 20 may be affixed to the static structure of the Aircraft cockpit as, for example, a Head Down Display (HDD) or Head Up Display (HUD) unit. Alternatively, display device 20 may assume the form of a movable display device (e.g., a pilot-worn display device) or a portable display device, such as an Electronic Flight Bag (EFB), a laptop, or a tablet computer carried into the Aircraft cockpit by a pilot.

In various embodiments, the HMI 106 further includes or has integrated therein an audio system capable of emitting speech and sounds, as well as of receiving speech input. In various embodiments, the HMI 106 may include any of: a graphical user interface (GUI), a speech recognition system, and a gesture recognition system. Via various display and graphics systems processes, the controller circuit 104 may command and control the generation, by the HMI 106, of a variety of graphical user interface (GUI) objects or elements described herein, including, for example, buttons, sliders, and the like, which are used to prompt a user to interact with the human-machine interface to provide user input, and to activate respective functions and provide user feedback, responsive to received user input at the GUI element.

The on-board systems 30 generally include a position-determining system 110 sensors, a weather radar system 112, various avionic systems 114, and a database 116. The on-board systems 30 may include a flight management system (FMS) 120.

The position-determining system 110 supplies various types of aircraft status data or measurements to controller circuit 104 and the communication bus 105 during aircraft flight. In various embodiments, the aircraft status data includes, without limitation, one or more of: inertial reference system measurements providing a location, Flight Path Angle (FPA) measurements, airspeed data, groundspeed data (including groundspeed direction), vertical speed data, vertical acceleration data, altitude data, attitude data including pitch data and roll measurements, yaw data, heading information, sensed atmospheric conditions data (including wind speed and direction data), flight path data, flight track data, radar altitude data, and geometric altitude data. The position-determining system 110 may be realized as one or more of a global positioning system (GPS), inertial reference system (IRS), or a radio-based navigation system (e.g., VHF omni-directional radio range (VOR) or long-range aid to navigation (LORAN)), and it may include one or more navigational radios or other sensors suitably configured to support operation of the aircraft 100. In some embodiments, the position-determining system 110 may also obtain and/or determine the heading of the aircraft 100 (i.e., the direction that aircraft 100 is traveling relative to some reference) using a magnet compass or a magnetometer, for example. The position-determining system 110 may also include a barometric altimeter such that the position of the aircraft 100 may be additionally determined with reference to a barometric altitude. In some embodiments, the GPS may alternatively or additionally provide altitude information as part of the position-determining system 110. As such, in an exemplary embodiment, the position-determining system 110 can obtain and/or determining the instantaneous position and altitude of the aircraft 100, and the position-determining system 110 generates aircraft status data for the aircraft, including the current location of the aircraft 100 (e.g., the latitude and longitude) and the altitude and heading of the aircraft 100. The position-determining system 110 may provide this aircraft status data to the controller circuit 104 and the flight management system 120 to support their operation, as described herein.

The weather radar system 112 provides weather data for the volume of space around the aircraft 100. In various embodiments, the weather radar system 112 is configured to generate reflectivity data at various altitudes over a geographic area (for example a distance range in front of the aircraft).

In contrast to the sensing functions provided by position determining system 110 and weather radar system 112, the avionic systems 114 represent onboard the engine and flight configuration equipment. Signals provided by onboard avionic systems may include an overheated engine, a faulty flap, a blade-out condition in an engine fan, and the like. Signals consumed by the avionic system 114 may include engine configuration commands, flap position commands, and the like.

In practice, the database 116 may be realized as one or more different onboard databases, each being a computer-readable storage media or memory. In various embodiments, two- or three-dimensional map data may be stored in the database 116, including airport features data, geographical (terrain), buildings, bridges, and other structures, street maps, and navigational databases, which may be updated on a periodic or iterative basis to ensure data timeliness. This map data may be uploaded into the database 116 at an initialization step and then periodically updated, as directed by either a program 15 update or by an externally triggered update.

Flight management system 120 provides the primary navigation, flight planning, and route determination and en route guidance for the aircraft 100. The flight management system 120 may contribute aircraft status data provided to controller circuit 104, such as, the aircraft's current position and flight direction (e.g., heading, course, track, etc.), the aircraft's airspeed, ground speed, altitude (e.g., relative to sea level), pitch, and other important flight information if such information is desired. In various embodiments, flight management system 120 may include any suitable position and direction determination devices that can provide controller circuit 104 with at least an aircraft's current position (e.g., in latitudinal and longitudinal form), the real-time direction (heading, course, track, etc.) of the aircraft in its flight path, and other important flight information (e.g., airspeed, altitude, pitch, attitude, etc.). Flight management system 120 and controller circuit 104 cooperate to guide and control aircraft 100 during all phases of operation, as well as to provide other systems of aircraft 100 with flight data generated or derived from flight management system 120.

As will be described in more detail below, the clearance database 118 is a storage location used by the system 102 during operation. In an embodiment, the system 102 may store execution data in a clearance lookup table in the clearance database 118. In various embodiments, the execution data is an ATCT log in the form of a data string comprising the ATC message, a target avionic system, a respective destination avionic system, and the respective avionic data. In an embodiment, the system 102 may store contextual information (e.g., via a contextual processing module) for various ATC messages such that they link the instructions within an ATC message to one or more destination avionic systems. The clearance database 118 may be stored in memory onboard the controller circuit 104, or in a separate storage or database 116. In various embodiments, the system 102 references the clearance database 118 to determine whether a pilot-initiated action (received via a cockpit display page, such as an FMS page 23) has an associated entry before displaying text or a graphical user interface (GUI) object on a respective display device 20.

It should be appreciated that aircraft 100 includes many more additional features (systems, databases, etc.) than the illustrated systems 105-118. For purposes of simplicity of illustration and discussion, however, the illustrated aircraft 100 omits these additional features.

External sources 50 may include a weather subscription service, other subscription service, traffic monitoring service, neighbor traffic, air traffic control (ATC), ground stations, and the like.

The term “controller circuit,” as appearing herein, broadly encompasses those components utilized to carry-out or otherwise support the processing functionalities of the system 102. Accordingly, controller circuit 104 can be implemented as a programmable logic array, application specific integrated circuit, system on a chip (SOC), or other similar firmware, as well as by a combination of any number of individual processors, flight control computers, navigational equipment pieces, computer-readable storage devices (including or in addition to memory 10), power supplies, storage devices, interface cards, and other standardized components.

In various embodiments, as depicted in FIG. 1, the controller circuit 104 embodies an enhanced computer system, having one or more processors 5 operationally coupled to computer-readable storage media or memory 10, having stored therein at least one novel firmware or software program 15 (generally, computer-readable instructions that embody an algorithm) for carrying-out the various process tasks, calculations, and control/display functions described herein. During operation, the controller circuit 104 may be programmed with and execute the at least one firmware or software program, for example, program 15, that embodies an algorithm for receiving, processing, mapping, contextualizing, generating, and altering renderings, described herein, to thereby perform the various process steps, tasks, calculations, and control/display functions described herein.

Controller circuit 104 may exchange data, including real-time wireless data, with one or more external sources 50, such as a configuration file manager or subscription service to support operation of the system 102 in embodiments. In this case, the controller circuit 104 may utilize the communications circuit 108 to manage bidirectional wireless data exchange over a communications network, such as a public or private network implemented in accordance with Transmission Control Protocol/Internet Protocol architectures or other conventional protocol standards. Encryption and mutual authentication techniques may be applied, as appropriate, to ensure data security. In various embodiments, the communications circuit 108 is integrated within the controller circuit 104.

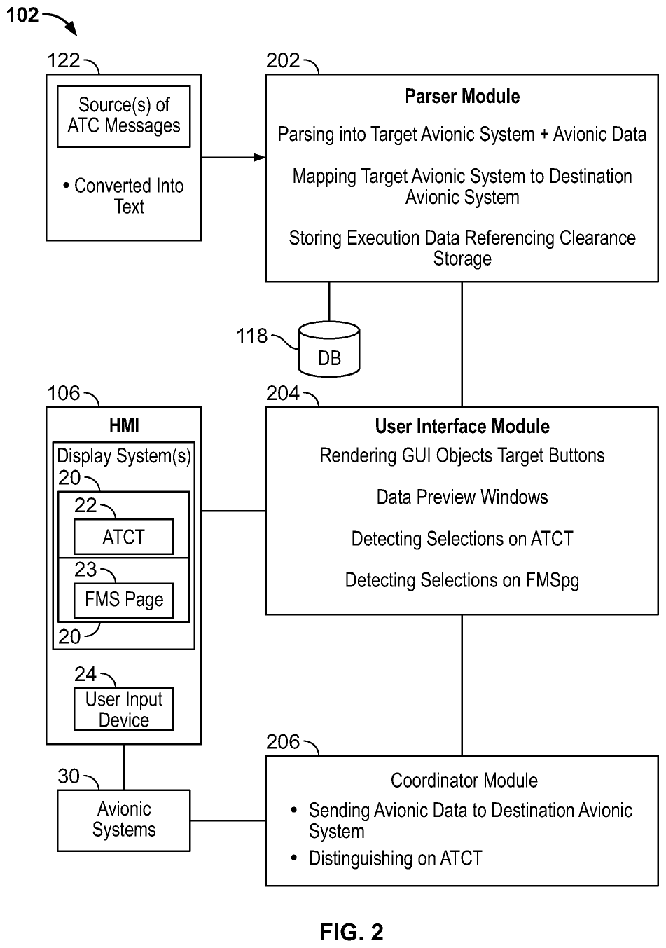

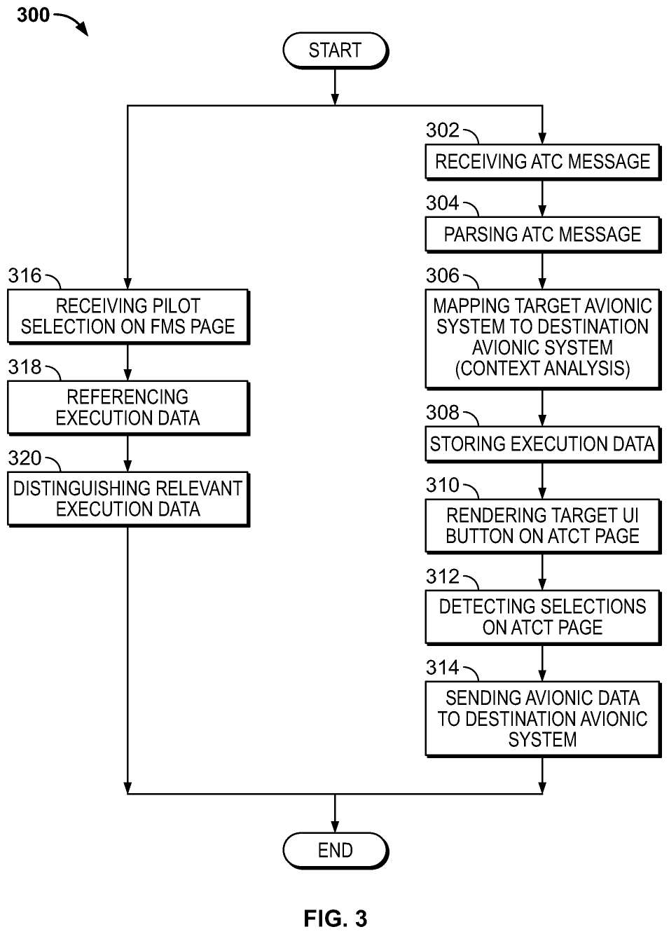

Turning now to FIGS. 2-3, and with continued reference to FIG. 1, the operation of the systems and methods of the present invention are described. FIG. 2 describes one or more application modules that may be operating in the system 102, with reference to example operations that they each may control. FIG. 3 provides a flowchart of a method 300 for on-demand enabling of display features for an avionic display in an aircraft while the aircraft is in flight is described, in accordance with exemplary embodiments of the present disclosure. For illustrative purposes, the following description of method 300 may refer to elements mentioned above in connection with FIG. 1. In practice, portions of method 300 may be performed by different components of the described system. It should be appreciated that method 300 may include any number of additional or alternative tasks, the tasks shown in FIG. 3 need not be performed in the illustrated order, and method 300 may be incorporated into a more comprehensive procedure or method having additional functionality not described in detail herein. Moreover, one or more of the tasks shown in FIG. 3 could be omitted from an embodiment of the method 300 if the intended overall functionality remains intact.

A parser module 202 may perform the operations of receiving (at 302) the ATC message from source 122 and parsing (at 304) the ATC message into a target avionic system (e.g., radio) and a respective avionic data.

The parser module 202 may perform the operation of mapping the target avionic system to a destination avionic system at 306. To perform 306, the system 102 may reference the clearance database 118 and execute mapping algorithms to put the ATC message into context of one or more destination avionic systems 30.

In various embodiments, the mapping algorithms include a publish-subscription module which implements a publish-subscribe pattern for speech data received from a speech processing system. In these embodiments, a pilot may define an interface for publishing topics, and associated pilot-defined published topics will be combined with the topics identified by the contextual processing module, which analyzes received speech, the output being “speech data of interest.” In these embodiments, non-limiting examples of a subscription client include avionic systems that may want to receive the “speech data of interest,” and include a Flight Plan system, a RAAS system, a TOLD system, and an EGPWS system. A respective client subscription component in each avionics sub system which receives the speech data of interest responsive to the publish-subscribe module generating the speech data of interest.

Non-limiting examples of ATC clearance messages and target avionic systems identified via the mapping algorithms are presented in Table 1.

TABLE 1

| ATC Message | avionic systems |
|---|---|
| SOUTHWEST SEVENTEEN FORTY-EIGHT | TOLD, EGPWS, |
| RUNWAY TWO SEVEN CLEARED FOR | FMS |
| TAKEOFF | |
| WIND IS ZERO SEVEN ZERO AT SIX | FMS, TOLD |
| SEVENTY-TWO FIVE TWO POINT FIVE | Displays |
| ALTIMETER | |
| CUTTER FOUR SEVEN LIMA TOUCH AND GO | TCAS, FMS |
| WE HAVE ZULU | |
| GO AROUND STRAIGHT-OUT PILATUS THREE | TCAS, FMS |
| EIGHT NINE | |
| SOUTHWEST FORTY-SEVEN TWENTY-EIGHT | RAAS |
| BOSTON TOWER CROSS RUNWAY THREE | |
| THREE LEFT | |
| DELTA TWO FORTY-TWO THANK YOU CROSS | RAAS |
| RUNWAY FOUR LEFT THEN CONTAC GROUN | |
| POINT NINE | |
| SIX TWELVE BOSTON TOWER THANK YOU | TOLD, |
| TRAFFIC'S A MILE AND A HALF FINAL | Displays |
| RUNWAY THREE THREE LEFT CLEAR TO LAN | |
| THE WIND'S TWO NINER ZERO ONE TWO | |
| GUSTS ARE ONE NINER TRAFFIC WILL HOLD | |
| ON A CROSSING RUNWAY | |
| CARE SIX TWELVE CAUTION WAKE | Displays |
| TURBULENCEON A SEVEN FIFTY-SEVEN ON A | |
| MILE FINAL | |
| JET EIGHT FORTY-TWO BOSTON TOWER | TOLD, |
| YOU'RE FOLLOWIN TRAFFIC ON A THREE | Displays |
| MILE FINAL RUNWAY THREE THREE LEFT | |
| CLEAR TO LAN WIN TWO NINER ZERO AT | |
| ONE ONE GUSTS ARE ONE NINER TRAFFIC | |
| WILL HOLD AT CROSSING RUNWAY | |
| D CSIXTY ONE TWENTY-NINE RUNWAY TWO | LIGHTS |
| SEVEN LINE UP AND WAIT TRAFFIC LINING | |
| RUNWAY THREE THREE LEFT | |
| SOUTHWEST SEVENTEEN FORTY-EIGHT | RADIOS |
| CONTAC DEPARTURE | |
| YEAH BRAKING ACTION POOR ON TEN LEFT | TOLD, Wheels, |
| HALF INCH AH WET | & Brakes |
| TEN LEFT HAS TOO MUCH CONTAMINATION | Wheels & |
| | Brakes |

At 308, the parser module 202 may also handle storage of execution data into the clearance database 118. The parser module 202 may store the execution data in a clearance lookup table, as a data string, the target avionic system, the destination avionic system, and the respective avionic data.

The user interface module 204 is in operable communication with the display device(s) 20 that render the ATCT page 22 and the display device(s) 20 that render a cockpit display page, such as the FMS page 23. The interface module 204 adds or overlays new graphical user interface (GUI) objects on the ATCT page 22 and detects additional user interactions on each of the ATCT page 22 and the FMS page 23.

At 310, the user interface module 204 may render a target user interface (UI) button on the ATCT page 22. For example, at 310, the user interface module 204 may display a target UI button to prompt the user to view a destination avionic system. In various embodiments, the system 102 determines that there are multiple target avionic systems, and at 310, the user interface module 204 displays a respective target UI button for each of the multiple target avionic systems.

At 312, a user interface module 204 may further detect user input on the ATCT page 22 (e.g., a user selection of a target UI button) and, responsive thereto, display a data preview window comprising the respective avionic data and a graphical user interface (GUI) object representing a destination avionic system associated with the target avionic system. In some embodiments, the data preview window overlays the entire area of an ATCT dialog box. In various embodiments, the system 102 determines that target avionic system has more than one potential destination avionic system, and at 312, the user interface module 204 displays a respective graphical user interface (GUI) object for each of the more than one potential destination avionic systems associated with the target avionic system.

At 314, a coordinator module 206 may perform the operations of sending the avionic data to the destination avionic system, responsive to receiving/detecting a user selection of the destination avionic system in the data preview page on the ATCT 22.

As mentioned, the user interface module 204 may also perform the task of detecting user/pilot selections made in the cockpit display page or FMS page 23 (at 316), such as knob rotation or any other input. Responsive to detecting user activity such as a user selection of a data entry on the FMS page 23, the interface module 204 may reference (at 318) the clearance database 118 to determine whether any execution data is relevant to the data entry that was selected. Responsive to determining that there is execution data that is relevant to the user activity on the FMS page (e.g., the data entry that was selected), the user interface module 204 may (at 320) visually distinguish the relevant execution data on the ATCT page. In an example embodiment, the user interface module 204 visually distinguishes the relevant execution data by highlighting it while keeping remaining text unhighlighted.

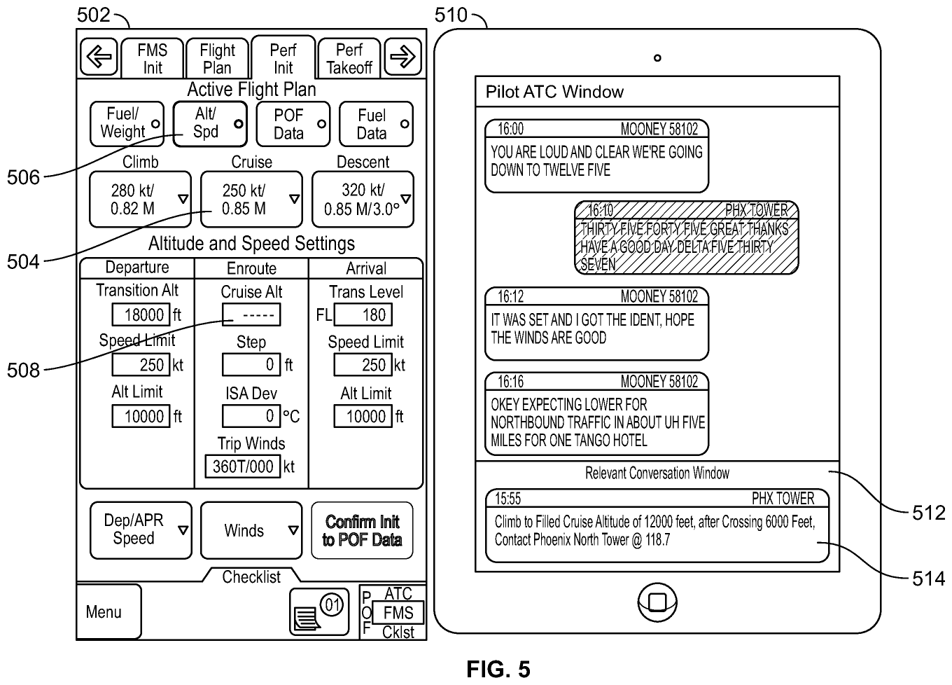

In another example, the system 102 may determine that an FMS page is rendered on a display system in the aircraft; and responsive to detecting user activity on the FMS page, (i) search the execution data for a relevant entry for the user activity, the relevant entry defined as having a parameter used for the selected user activity, and (ii) overlay a relevant conversation window on the ATCT page on the portable device, the relevant conversation window rendering an alphanumeric message associated with the relevant entry (see FIG. 5 for an example relevant conversation window). Non-limiting examples of the parameter used for the operation includes one or more of: an altitude, a ground speed, an air temperature, a runway, an arrival procedure, and a departure procedure.

From 314 or 320, the method 300 may end or cycle back to the start. In various embodiments, the method 300 can keep cycling until the aircraft lands.

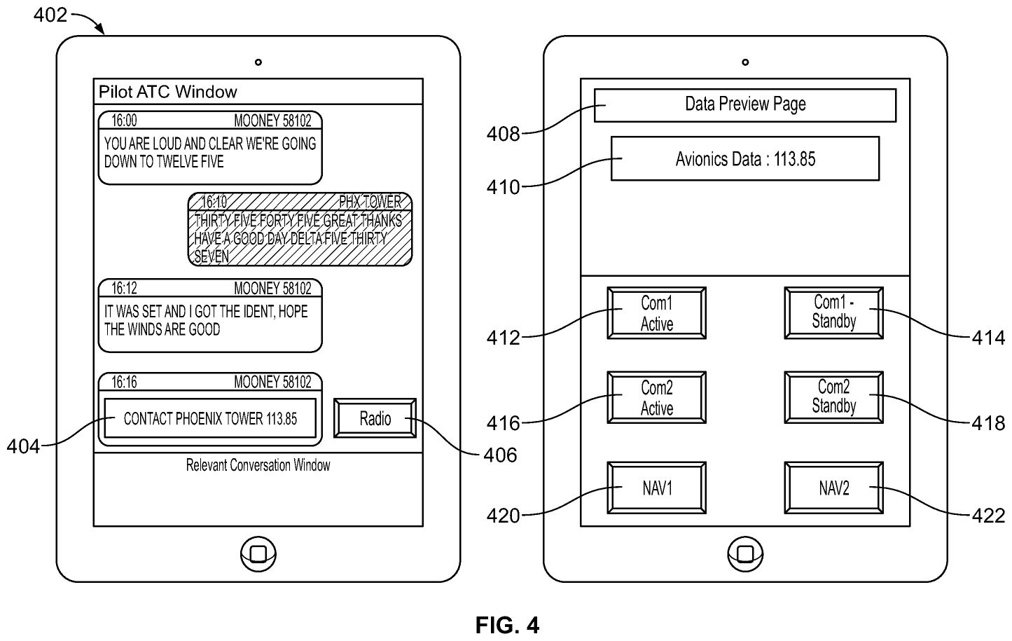

FIG. 4 provides an example use case. The ATCT page 402 is displayed. The ATC message 404 is a recognized ATC clearance message, and the system 102 has identified “Radio” as the single target avionic system. If another target avionic system were identified, it would be displayed alongside the “Radio” target UI button 406. Responsive to receiving a pilot selection of the “Radio” target UI button 406, the data preview page 408 is displayed on the ATCT display device. Data preview page 408 displays the avionic data 410 (“Avionics data: 113.85” in this example), and one or more potential destination avionic systems. In this example, there are six potential destination avionic systems: Com1 Active (412), Com1 Standby (414), Com2 Active (416), Com2 Standby (418), Nav1 (420) and Nav2 (422). As mentioned above, responsive to receiving a pilot selection of one of the potential destination avionic systems, the avionics data 410 will be automatically sent to the selected destination avionic systems, without further user input.

FIG. 5 provides another example use case. In this example, the pilot has navigated to the Active Flight Plan on a “Perf Init” tab on the FMS page 502, and data elements associated with the active flight plan are displayed. The pilot selects “Cruise” 504 and, responsive thereto, the system 102 references previous ATCT logs in the execution data stored in the clearance database 118, and promptly, responsive to finding relevant execution data, and without further user input, displays it on the ATCT page 22. As mentioned above, these ATCT logs store the avionic data and the ATC message. In this example, the relevant execution data found and displayed for Cruise 504 is an ATC message, “Climb to 12000 feet, after crossing 6000 feet, contact Phoenix North Tower @ 118.7” after departure (514, displayed in the relevant conversation window 512 that is overlaid on the ATCT page 510.

In various embodiments, any action a pilot starts taking on the FMS page 23, e.g., by starting to dial a knob or entering the data field, will trigger the search of the execution data in the clearance database 118 and display relevant execution data promptly, and without further user input, in ATCT window 22.

Accordingly, the present disclosure has provided several embodiments of systems and methods for providing a user interface (UI) between an air traffic control ATC-Pilot conversation window on a portable device and a destination avionics system. The target UI button provided on the ATCT page enables quick access to the avionic data associated with an ATCT message. Additionally, a pilot may bring up an ATCT message that is tied to (relevant to) a data field the pilot has navigated to on an FMS page. The disclosed systems and methods provide an objectively improved HMI over available avionics display systems, at least in part, by adding new features and responses to each of the ATCT page 22 and to the FMS page 23.

Although an exemplary embodiment of the present disclosure has been described above in the context of a fully-functioning computer system (e.g., system 102 described above in conjunction with FIG. 1), those skilled in the art will recognize that the mechanisms of the present disclosure are capable of being distributed as a program product (e.g., an Internet-disseminated program 15 or software application) and, further, that the present teachings apply to the program product regardless of the particular type of computer-readable media (e.g., hard drive, memory card, optical disc, etc.) employed to carry-out its distribution.

Terms such as “comprise,” “include,” “have,” and variations thereof are utilized herein to denote non-exclusive inclusions. Such terms may thus be utilized in describing processes, articles, apparatuses, and the like that include one or more named steps or elements but may further include additional unnamed steps or elements.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A system providing a user interface (UI) between an air traffic control transcription (ATCT) page on a portable device and a destination avionics system, the system comprising:
a parser module configured to:
receive an air traffic control (ATC) message;
parse the ATC message into a target avionic system and a respective avionic data;
map the target avionic system to a destination avionic system; and
store in a clearance database, execution data comprising the ATC message, the target avionic system, the destination avionic system, and the respective avionic data;
a user interface (UI) generator module configured to:
render, on the ATCT page, a target UI button to indicate the target avionic system in the ATC message;
display, responsive to a user selection of the target UI button, a data preview window comprising the respective avionic data and a GUI object representing the destination avionic system; and
a coordinator module configured to send the avionic data to the destination avionic system, responsive to a user selection of the GUI object representing the destination avionic system.

2. The system of claim 1, wherein:
the parser module further configured to:
map the target avionic system into multiple destination avionic systems; and
store, as a data string, the target avionic system, the multiple destination avionic systems, and the respective avionic data; and
the UI generator module further configured to:
display, responsive to the user selection of the target UI button, the data preview window comprising the respective avionic data and, for each of the multiple destination avionic systems, a respective GUI object representing the destination avionic system.

3. The system of claim 1, wherein the avionic data in the data preview window is editable.

4. The system of claim 1, wherein the data preview window further comprises a UI object for the destination avionic system, and wherein the coordinator module is further configured to send the avionic data to the destination avionic system, responsive to a user selection of the UI object for the destination avionic system.

5. The system of claim 2, wherein the data preview window further comprises a UI object for each of multiple destination avionic systems, and wherein the coordinator module is further configured to determine, from the data preview window, a user-selected destination avionic system from among the multiple destination avionic systems and send the avionic data to the user-selected destination avionic system, responsive to a user selection of the UI object for the destination avionic system.

6. The system of claim 1, wherein
the parser module is further configured to:
parse the ATC message into two or more target avionic systems, each having a respective avionic data;
for each of the two or more target avionic systems, map the target avionic system to a respective destination avionic system; and
for each of the two or more target avionic systems, store, as a data string, the target avionic system, the destination avionic system, and the respective avionic data;
the user interface (UI) generator module further configured to:
for each of the two or more target avionic systems, render, on the ATCT page, a respective target UI button to indicate the target avionic system;
display, responsive to a user selection of a target UI button from among the two or more target UI buttons, the data preview window comprising, for the selected target UI button, the respective avionic data and a GUI object representing the destination avionic system.

7. The system of claim 6, wherein the data preview window further comprises a next UI object, and wherein the coordinator module is further configured to close the data preview window and restore the ATCT page, responsive to a user selection of the next UI object.

8. The system of claim 1, wherein the coordinator module is further configured to:
determine that a cockpit display page is rendered on a display system in the aircraft; and
responsive to detecting user activity on the cockpit display page, (i) searching the execution data for a relevant entry for the user activity, the relevant entry defined as having a parameter used for the selected user activity, and (ii) overlaying a relevant conversation window on the ATCT page on the portable device, the relevant conversation window rendering an alphanumeric message associated with the relevant entry.

9. The system of claim 8, wherein the parameter used for the operation includes one or more of: an altitude, a ground speed, an air temperature, a constraint, a frequency, a waypoint, a runway, an arrival procedure, and a departure procedure.

10. A method providing a user interface (UI) between an air traffic control transcription (ATCT) page on a portable device and a destination avionics system, the method comprising:
at a controller circuit,
receiving an air traffic control (ATC) message;
parsing the ATC message into a target avionic system and a respective avionic data;
mapping the target avionic system to a destination avionic system; and
rendering, on the ATCT page, a target UI button to indicate the target avionic system in the ATC message;
displaying, responsive to a user selection of the target UI button, a data preview window comprising the respective avionic data and a GUI object representing the destination avionic system; and
sending the avionic data to the destination avionic system, responsive to a user selection of the GUI object representing the destination avionic system.

11. The method of claim 10, further comprising:
mapping the target avionic system into multiple destination avionic systems; and
displaying, responsive to the user selection of the target UI button, the data preview window comprising the respective avionic data and, for each of the multiple destination avionic systems, a respective GUI object representing the destination avionic system.

12. The method of claim 10, further comprising:
detecting user activity on a cockpit display page;
referencing a clearance database having stored therein, execution data comprising the ATC message, the target avionic system, the destination avionic system, and the respective avionic data to determine whether any execution data is relevant to the user activity on the cockpit display page, responsive to the user activity on the cockpit display page.

13. The method of claim 10, wherein the data preview window further comprises a UI object for the destination avionic system, and further comprising, sending the avionic data to the destination avionic system, responsive to a user selection of the UI object for the destination avionic system.

14. The method of claim 13, wherein the data preview window further comprises a send UI object, and wherein the coordinator module is further configured to determine, from the data preview window, a user-selected destination avionic system from among the multiple destination avionic systems and send the avionic data to the user-selected destination avionic system, responsive to a user selection of the send UI object and the user selection of the destination avionic system.

15. The method of claim 10, further comprising:
parsing the ATC message into two or more target avionic systems, each having a respective avionic data;
for each of the two or more target avionic systems, mapping the target avionic system to a respective destination avionic system;
for each of the two or more target avionic systems, rendering, on the ATCT page, a respective target UI button to indicate the target avionic system; and
displaying, responsive to a user selection of a target UI button from among the two or more target UI buttons, the data preview window comprising, for the selected target UI button, the respective avionic data and a GUI object representing the destination avionic system.

16. The method of claim 15, wherein the data preview window further comprises a next UI object, and wherein the coordinator module is further configured to close the data preview window and restore a previous ATCT page, responsive to a user selection of the next UI object.

17. The method of claim 10, wherein a FMS page is rendered on a display system fixed within the aircraft, and the ATCT page is on a personal electronic device, and further comprising:
responsive to detecting user activity on the FMS page, (i) searching the clearance database for a relevant entry, and (ii) overlaying a relevant conversation window on the ATCT page, the relevant conversation window rendering an alphanumeric message associated with the relevant entry.

18. The method of claim 17, wherein the alphanumeric message includes one or more of: an altitude, a ground speed, an air temperature, a constraint, a frequency, a waypoint, a runway, an arrival procedure, and a departure procedure.

19. A system providing a user interface (UI) between an air traffic control transcription (ATCT) page on a portable device and multiple destination avionic systems onboard an aircraft, the system comprising:
a processor operationally coupled to the portable device and the multiple destination avionic systems, and configured to:
receive an air traffic control (ATC) message;
parse the ATC message into a target avionic system and a respective avionic data;
map the target avionic system to a destination avionic system of the multiple destination avionic systems on the aircraft; and
render, on the ATCT page, a target UI button to indicate the target avionic system in the ATC message;
display, responsive to a user selection of the target UI button, a data preview window comprising the respective avionic data and a GUI object representing the destination avionic system; and
sending the avionic data to the destination avionic system, responsive to a user selection of the GUI object representing the destination avionic system.

20. The system of claim 19, wherein the target avionic system is a radio.
